(19) United States
(12) Patent Application Publication
(10) Pub. No.: US 2007/0033520 A1
(43) Pub. Date: Feb. 8, 2007

(54) System and method for web page localization

(76) Inventors: Ann M. Kimzey, Loveland, CO (US); Cory V. Atkin, Loveland, CO (US)

Correspondence Address: AVAGO TECHNOLOGIES, LTD., P.O. BOX 1920, DENVER, CO, 80201-1920, US

(21) Appl. No.: 11/198,949

(22) Filed: Aug. 8, 2005

(51) Int. Cl. G06F 17/24

(52) U.S. Cl. 715/513

(57) ABSTRACT

A system and method for localizing web pages automatically replacing strings with codes in a preselected way, associating the strings with the codes, localizing the strings, and compiling the web pages having the codes and localized strings. When a request for a web page arrives, the locale is determined, the codes are located in the modified web page associated with the requested web page and used as indices, along with the locale, into the set of localized strings. The strings at the location of the codes are dynamically replaced, in a data stream that forms a localized web page, automatically with their localized versions, thus localizing the web page.

### BACKGROUND OF THE INVENTION

This invention relates generally to web page localization, and more specifically to a system and method for localizing web page content by use of tags. Web page localization refers to the process of customizing a web page so that it can be viewed by a user with the user's chosen customizations, such as a user's chosen language.

When the localization is a translation, some systems of the prior art translate the whole page before presenting the information to the user, a system known as static translation. These types of systems require enough storage to store the entire page translated into each possible language. Another disadvantage is that further localization requires a search through the web page for key strings.

Other systems of the prior art, when applied to localization of language, can use what are known as resource bundles which is a facility for internationalization that includes files that store text messages displayed by a JAVA program. When a JAVA program uses resource bundles, it loads its text messages from the resource bundle to be displayed to a user. By separating text messages from the program code that displays them, it becomes easier to generate versions of a program that display in different languages. A drawback of resource bundles is that it may be difficult for a translator to determine, without further information, the context in which to understand and translate the text of the resource bundle. Systems of the prior art resolve this problem by providing additional input controls in the form of executable code in the web page that can assist the translator in performing translations on web site text without having to refer to resource bundles or source code to make corrections to the translation. For example, the translator can be allowed to enter translation text and press “enter” or “return” on the computer keyboard to submit the translation. Once the translation has been submitted for entry, the resource bundle containing the translated text is modified to include the new translation in place of the original text, and the web page may be redisplayed with the new translated text.

Still other prior art systems localize web pages based on a selected characteristic such as culture, a sin, a filtered set of functions, or other desired trait. In a system such as this, each instance of a control type in a web page that is to be localized includes a configurable key attribute that refers to a localization element of one or more localized property values for the control type. During the rendering of the web page, the localized property values corresponding to the control type and selected characteristic are automatically applied to each instance that includes the key. A graphic user interface is provided for defining and managing localization elements in a database to generate resource files used for localizing the web page.

Both of these types of systems require manual intervention to localize. In the first type of system, a translator replaces text both within a resource bundle for later use and within a web page. In the second type of system, the user must define and manage localization elements that are part of resource files that are used to localize the web page. What is needed is a system and method that perform localization based on preselected markers that can be used to surround web page elements that are to be localized.

Yet still other systems of the prior art can display dynamic web content of web pages created with standard editors. The program code necessary to gather and process the dynamic content is inserted into the web document source surrounded by special symbols or tags. When a page utilizing the special symbols or tags is requested, a pre-processor evaluates the symbols or tags and replaces code within the document with the results of evaluating the code. For example, a code snippet surrounded by special symbols that would direct the pre-processor to retrieve information from a database would be executed by the pre-processor to retrieve the information, then the portion of the web document source occupied by the code snippet would be removed and replaced with the retrieved information before serving the web page to a browser. These types of systems require the web page developer to understand the system of symbols and tags, and require the pre-processor developer to create a complicated evaluation system for parsing the symbols, tags, and web page content.

Therefore, there is a need to provide a system and method for fully automating the dynamic localization of web pages in a space constrained embedded environment. A system and method are needed that provide for localizing web page content that requires little or no manual intervention.

### SUMMARY OF THE INVENTION

The needs set forth above as well as further and other needs and advantages are addressed by the present invention. The solutions and advantages of the present invention are achieved by the illustrative embodiment described herein below.

The system and method of the present invention provide for localizing a web page by a system that includes modifying the web page by automatically replacing at least one string in the web page with at least one code associated with the at least one string. This step creates a modified web page and a data structure that associates the at least one code with the at least one string. The system and method provide for localizing the data structure, for example by the use of a conventional localization house, to produce localized string modules. The localized string modules and the modified web page are compiled, using a conventional product compiler, into a product. The product is in electronic communications, for example through a communications network, with a browser from which a request for a web page emanates. The product can receive the request for the web page and, at the same time, determine a locale of the request. The product can continue by parsing the modified web page associated with the web page request to locate the at least one code, and determine from the at least one localized string module a localized string based on the at least one code and the locale. The product can then replace the at least one code with the localized string from the localized string module that is associated with the at least one code and the locale. The process of replacing the at least one code with the localized string has the effect of creating a localized web page that the product can then provide to a browser that is in electronic communications with the product through, for example, a communications network. The at least one code can, for example, be a preselected token, and can, for example, be preceded by a comment indicator.

For a better understanding of the present invention, together with other and further objects thereof, reference is made to the accompanying drawings and detailed description. The scope of the present invention is pointed out in the appended claims.

### DESCRIPTION OF THE SEVERAL VIEWS OF THE DRAWING

FIG. 1 is a schematic block diagram of the system of the present invention;

FIG. 2 is a schematic block diagram of the system of the present invention including the components of the pre-processor and the product;

FIG. 3A is an exemplary string→code conversion performed by the pre-processor;

FIG. 3B is an exemplary code→string conversion performed by the product; and

FIGS. 4A and 4B are flowcharts of the method of the present invention.

### DETAILED DESCRIPTION OF THE INVENTION

The present invention is now described more fully hereinafter with reference to the accompanying drawings, in which the illustrative embodiment of the present invention is shown. The following configuration description is presented for illustrative purposes only. Any computer configuration satisfying the speed and interface requirements herein described may be suitable for implementing the system of the present invention. The localization example presented herein involves language translation, but the invention is not limited to localization involving language translation.

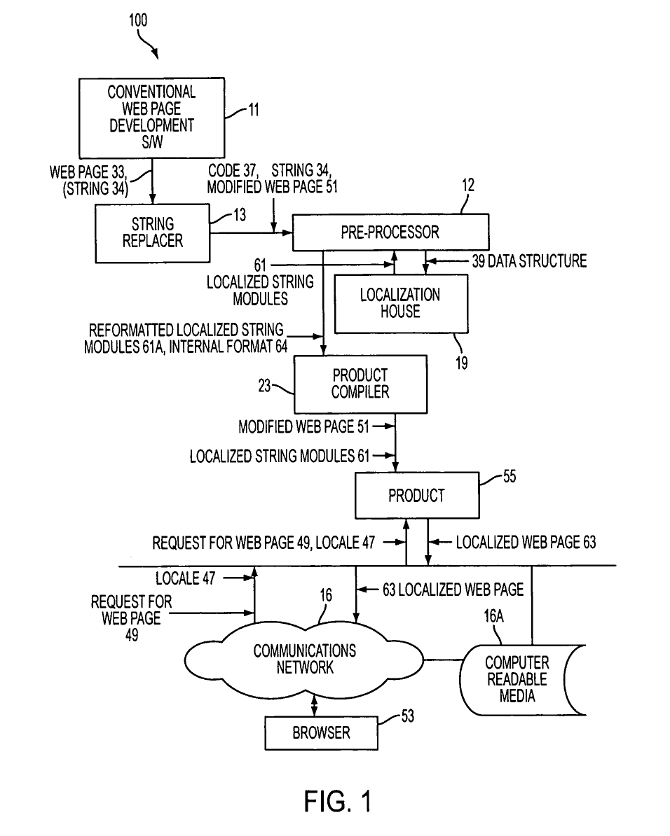

Referring now to FIG. 1, system 100 of the present invention can include, but is not limited to, string replacer 13, pre-processor 12, and product 55. String replacer 13 can receive a user-created web page 33 from conventional web page development software 11, for example, eBusiness Builder™ by Plexus. String replacer 13 can search for at least one string 34 of interest, for example, English language strings, replaced it with code 37, prepare modified web page 51 having at least one string 34 replaced with code 37, and provide modified web page 51 and code/string information to pre-processor 12. Pre-processor 12 can create data structure 39 that relates code 37 to at least one string 34 and provides data structure to conventional localization house 19 such as, for example, a localization house provided by Ficorp, Inc. Localization house 19 can convert data structure 39 into localized string modules 61. Pre-processor 12 can convert localized string modules 61 into reformatted localized string modules 61A having the format required by product compiler 23. Pre-processor 12 can also compile modified web page 51 into an internal format 64 needed by product compiler 23. Pre-processor 12 can provide reformatted localized string modules 61A and internal format 64 to product compiler 23 which creates product 55.

Continuing to refer to FIG. 1, when a request 49 for a web page is generated by browser 53 and proceeds, through communications network 16, to product 55, product 55 determines locale 47 of request 49 and determines modified web page 51 that is associated with request 49. Product 55 parses modified web page 51 and locates code 37. Product 55 uses code 37 and locale 47 to index into localized string modules 61 to determine the correct string 34 with which to replace code 37 to create localized web page 63. After all codes 37 are replaced, product 55 provides localized web page 63 to browser 53 through communications network 16.

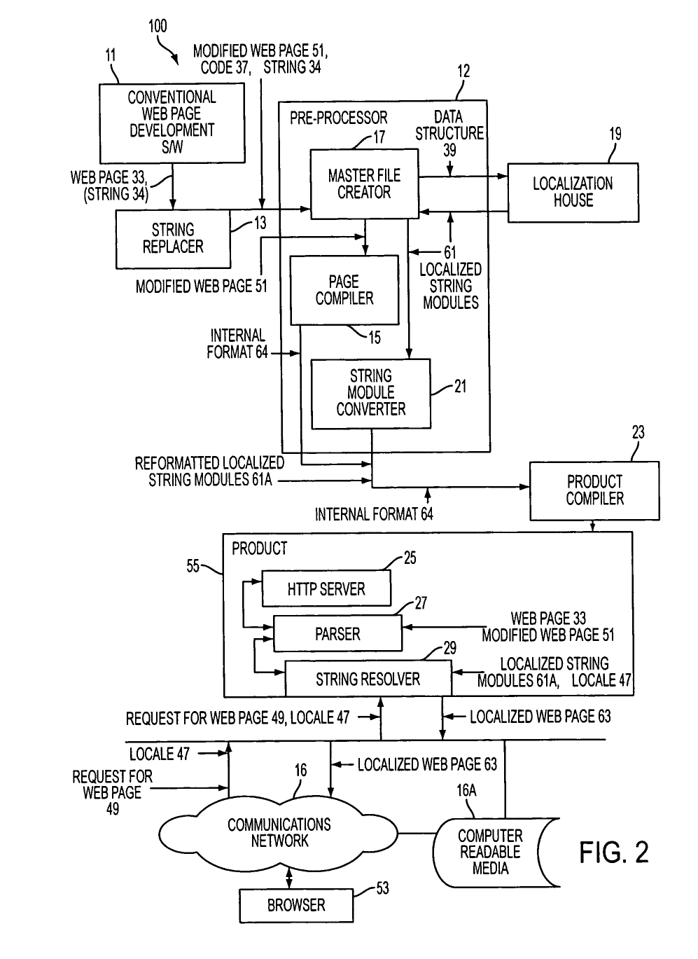

Referring now to FIG. 2, pre-processor 12 can include, but is not limited to master file creator 17, page compiler 15, and string module converter 21. Master file creator 17 receives modified web page 51 containing code 37 replacing at least one string 34, organizes the incoming information into data structure 39, and provides data structure 39 to localization house 19 which provides localized string modules 61. Master file creator 17 provides modified web page 51 to page compiler 15, which converts modified web page 51 into internal format 64 suitable for input to product compiler 23. Master file creator 17 also provides localized string modules 61 to string module converter 21 which creates reformatted localized string modules 61A having input suitable for product compiler 23. Product compiler 23 creates product 55.

Continuing to refer to FIG. 2, product 55 can include, but is not limited to, HTTP server 25, parser 27, and string resolver 29. HTTP server 25 is the entry point for request 49. HTTP server 25 communications to parser 27 the web page 33 that has been requested. HTTP server 25 also determines locale 47 of request 49. Parser 27 selects modified web page 51 that corresponds to web page 33 associated with request 49. Parser 27 locates code 37 and invokes string resolver 29. String resolver 29 uses code 37 and locale 47 to determine, from localized string modules 61A, the proper localized string to replace code 37 and at least one string 34. HTTP server creates, from the localized strings, localized web page 63 and provides localized web page 63 to browser 53 through communications network 16.

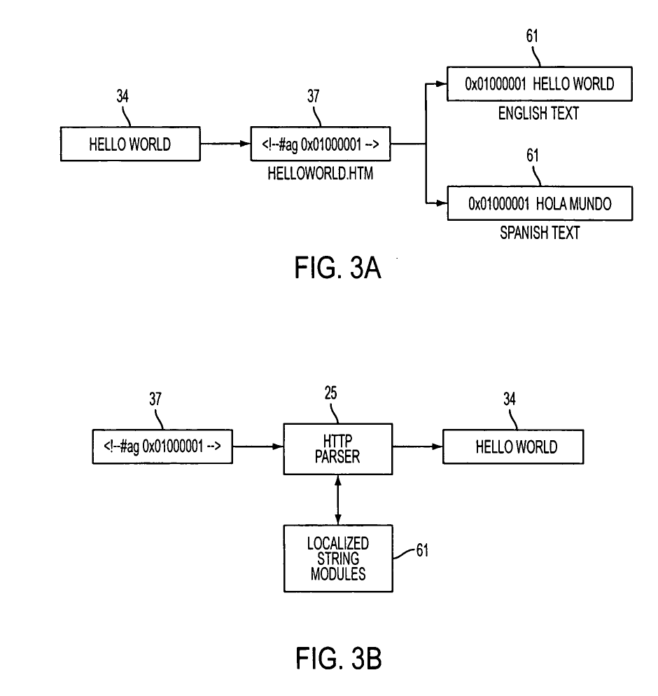

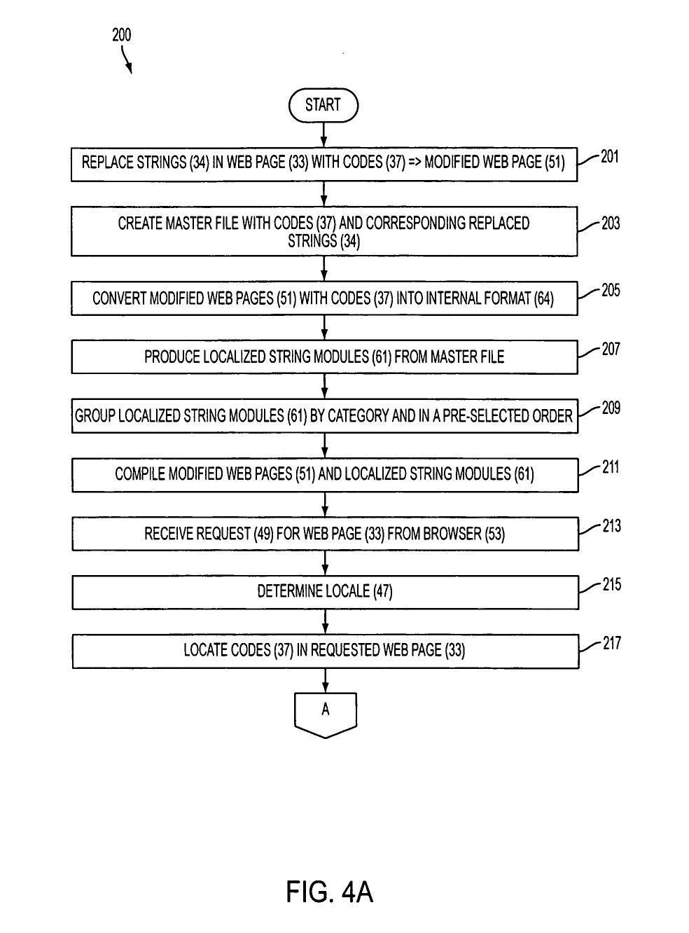

Referring now primarily to FIG. 3A, an example of at least one string 34, code 37, and localized string modules 61 is provided. Conventional web page development software 11 (FIGS. 1 and 2) allows a user to create at least one string 34 such as “Hello World” in a web page. At least one string 34 is provided to string replacer 13 (FIGS. 1 and 2) which replaces at least one string 34 with code 37. For example, the first byte of code 37 can act as a category marker, and the last three bytes can act as a unique string identifier in the category. This configuration can provide 256 possible categories and over sixteen million unique strings in each category. This code can be embedded into an HTML comment having the token “ag” preceding it as shown in FIG. 3. Embedding code 37 into a comment hides it from browser 53 (FIGS. 1 and 2) so that web page 33 (FIGS. 1 and 2) can be viewed for editing. Master file creator 17 (FIGS. 1 and 2) can provide data structure 39 (FIGS. 1 and 2), containing code 37 and its corresponding string 34, to localization house 19 (FIGS. 1 and 2) which generates files having code 37 with foreign language versions of string 34, one language per file. Master file creator 17 also can convert strings 34 from each language into localized string modules 61. Strings 34 in a language can be grouped into tables based on category and placed in sequential order in the category table.

Referring now primarily to FIG. 3B, after product compiler 23 (FIGS. 1 and 2) compiles modified web pages containing code 37 and localized string modules 61 into product 55 (FIGS. 1 and 2), the user can set the current language (or locale 47 (FIGS. 1 and 2)) on an embedded device. When request 49 (FIGS. 1 and 2) for web page 33 (FIGS. 1 and 2) is received at product 55, HTTP server 25 can parse modified web page 51 (FIGS. 1 and 2) corresponding to request 49 to find code 37. HTTP server 25 can use the first byte of code 37 (“01”) to index into the correct localized string module 61 in the selected language. HTTP server 25 can use the last three bytes (“000001”) to locate the correct string and insert the string into a data stream that contains the contents of localized web page 64.

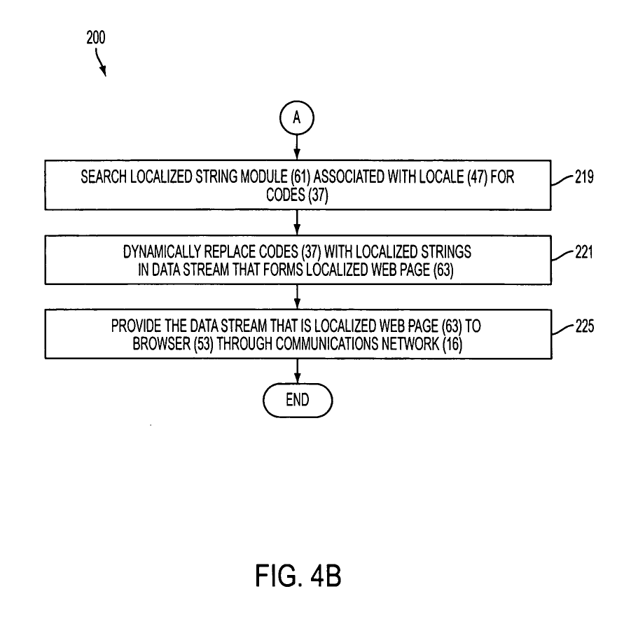

Referring now primarily to FIGS. 4A and 4B, method 200 of the present invention can include, but is not limited to, the steps of replacing at least one string 34 (FIGS. 1 and 2) in web page 33 (FIGS. 1 and 2) with code 37 (FIGS. 1 and 2) and creating modified web page 51 (FIGS. 1 and 2) (method step 201). Method 200 can also include the steps of creating a master file having code 37 and corresponding string 34 (method step 203), converting modified web page 51 (FIGS. 1 and 2) into internal format 64 (FIGS. 1 and 2) (method step 205), and producing localized string modules 61 (FIGS. 1 and 2) from the master file (method step 207). Method 200 can also include the steps of grouping localized string modules 61 by category and in a preselected order (method step 209) and compiling modified web pages 51 and localized string modules 61 to form product 55 (method step 211). Method 200 can further include the steps of receiving request 49 (FIGS. 1 and 2) for web page 33 from browser 53 (FIGS. 1 and 2) (method step 213), determining locale 47 (FIGS. 1 and 2) (method step 215), and locating code 37 in modified web page 51 that corresponds to request 49 (method step 217). Method 200 can still further include the steps of searching localized string module 61 associated with locale 47 for code 37 (method step 219), dynamically replacing code 37 with localized string in data stream that forms localized web page 63 (FIGS. 1 and 2) (method step 221), and providing data stream to browser 53 (FIGS. 1 and 2) through communications network 16 (FIGS. 1 and 2).

Method 200 (FIGS. 4A and 4B) can be, in whole or in part, implemented electronically. Signals representing actions taken by elements of system 100 (FIGS. 1 and 2) can travel over electronic communications media. Control and data information can be electronically executed and stored on computer-readable media 16A. The system can be implemented to execute on at least one node in at least one communications network 16 (FIG. 1). Common forms of computer-readable media 16A include, for example, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, or any other medium from which a computer can read.

Although the invention has been described with respect to various embodiments, it should be realized this invention is also capable of a wide variety of further and other embodiments.

What is claimed is:

1. A system for providing a localized web page comprising:
means for modifying the web page by automatically replacing at least one string in the web page with at least one code associated with said at least one string to create a modified web page;
means for creating a data structure associating said at least one string with said at least one code;
means for localizing said data structure to create at least one localized string module;
means for compiling said at least one localized string module and the modified web page into a product;
means for receiving, at said product, a request for the web page;
means for determining a locale;
means for parsing the modified web page associated with the web page request to locate said at least one code;
means for determining from said at least one localized string module a localized string based on said at least one code and said locale; and
means for dynamically and automatically replacing, in a data stream that forms a localized web page, said at least one code with said localized string from said localized string module that is associated with said at least one code and said locale in order to provide said localized web page.

2. The system of claim 1 further comprising:
means for choosing said at least one code based on a category marker and a string identifier within a category associated with said category marker.

3. The system of claim 1 wherein said at least one code includes a preselected token.

4. The system of claim 1 wherein said at least one code is preceded by a comment indicator.

5. The system of claim 1 further comprising:
means for converting the modified web page into an internal format; and
means for grouping said at least one localized string module into at least one category and in a preselected order.

6. A system for providing a localized web page comprising:
web page development software capable of allowing the creation of the web page including at least one string;
a string replacer capable of modifying the web page by automatically replacing said at least one string in the web page with at least one code;
a pre-processor capable of creating a data structure associating said at least one string with said at least one code, said pre-processor) capable of localizing said data structure to produce at least one localized string module, said pre-processor) capable of compiling said at least one localized string module and said modified web page to produce a product;
wherein said product is capable of receiving a request for the web page, parsing said modified web page associated with the request to detect said at least one code, determining from said at least one localized string module a localized string based on said at least one code and said locale, and dynamically and automatically replacing, in a data stream that forms a localized web page, said at least one code with said localized string in order to provide said localized web page.

7. The system of claim 6 wherein said pre-processor comprises:
a master file creator capable of creating a master file that contains said data structure.

8. The system of claim 6 further comprising:
a string module converter capable of converting said modified web page into an internal format.

9. The system of claim 6 further comprising:
a localization house capable of localizing said data structure to produce at least one localized string module; and
a product compiler capable of compiling said at least one localized string module and the modified web page to produce said product.

10. The system of claim 9 wherein said pre-processor comprises:
a string module converter capable of providing said data structure to said localization house and receiving said at least one localized string module from said localization house, said string module converter capable of providing said at least one string module and the modified web page to said product compiler.

11. The system of claim 6 wherein said at least one code is preceded by a comment indicator.

12. A method for providing a localized web page comprising the steps of:
modifying the web page by automatically replacing at least one string in the web page with at least one code associated with the at least one string to create a modified web page;
creating a data structure associating the at least one code and the at least one string;
localizing the data structure to produce localized string modules;
compiling the localized string modules and the modified web page into a product;
receiving, at the product, a request for the web page;
determining a locale;
parsing the modified web page associated with the request to locate the at least one code;
determining from the at least one localized string module a localized string based on the at least one code and the locale; and
dynamically and automatically replacing, in a data stream that forms a localized web page, the at least one code with the localized string from the at least one localized string module that is associated with the at least one code and the locale to provide a localized web page.

13. The method of claim 12 further comprising the steps of:
converting the modified web page into an internal format; and
grouping the at least one localized string module into at least one category and in a preselected order.

14. The method of claim 12 further comprising the step of:
providing the localized web page to a browser through a communications network.

15. The method of claim 12 further comprising the step of:
choosing the at least one code based on a category marker and a string identifier within a category associated with the category marker.

16. The method of claim 12 further comprising the step of:
including a preselected token in the at least one code.

17. The method of claim 12 further comprising the step of:
preceding the at least one code by a comment indicator.

18. A computer electronically connected to a communications network capable of carrying out the method according to claim 12.

19. A computer data signal embodied in electromagnetic signals traveling over a communications network carrying information capable of causing a computer electronically connected to the communications network to practice the method of claim 12.

20. A computer readable medium having instructions embodied therein for the practice of the method of claim 12.
